(19) United States
(12) Patent Application Publication
(10) Pub. No.: US 2022/0126681 A1
(43) Pub. Date: Apr. 28, 2022

(54) SANDWICH MOTOR VEHICLE TANK COMPRISING A BARRIER FILM AND INJECTION-MOLDED INNER TANK WALLS AND OUTER TANK WALLS

(71) Applicant: Röchling Automotive SE & Co. KG, Mannheim (DE)

(72) Inventors: Dieter Kerschbaumer, Tramin (IT); Petru-Sorin Muj, Bolzano (IT); Ivan De Metri, Bolzano (IT)

(21) Appl. No.: 17/506,780

(22) Filed: Oct. 21, 2021

(30) Foreign Application Priority Data
Oct. 23, 2020 (DE) 10 2020 128 011.4

(51) Int. Cl. B60K 15/03

(52) U.S. Cl. CPC B60K 15/03; B60K 2015/03453; B60K 2015/03493; B60K 2015/03065

(57) ABSTRACT

A motor vehicle tank, having a first tank shell and a second tank shell, the first tank shell and the second tank shell defining between each other at least one section of a tank volume of the motor vehicle tank, the first tank shell and the second tank shell respectively having an edge area having a joining flange, the first tank shell and the second tank shell being integrally joined to each other at their joining flanges across a common joining surface, the first tank shell and the second tank shell respectively being a multicomponent tank shell, which includes a barrier film and at least on its edge area an inner wall section that is injection molded onto the inner side of the barrier film pointing toward the tank volume as well as an outer wall section injection molded onto the outer side of the barrier film pointing away from the tank volume, wherein the barrier film of each tank shell is formed in such a way that with the approach to the common joining surface in the area of the joining flange it runs away from the tank volume and toward the outer tank side, so that an integral joint of the tank shells is formed from a first joining area situated closer to the tank volume, in which the injection molded inner tank wall sections of the two tank shells are joined to each other, and a second joining area situated further removed from the tank volume, in which the barrier films of the two tank shells are joined to each other.

This Application claims priority in German Patent Application DE 10 2020 128 011.4 filed Oct. 23, 2020, which is incorporated by reference herein.

The present invention relates to a motor vehicle tank, comprising a first tank shell and a second tank shell, the first tank shell and the second tank shell defining between each other at least one section of a tank volume of the motor vehicle tank, the first tank shell and the second tank shell respectively having an edge area having a joining flange, the first tank shell and the second tank shell being integrally joined to each other at their joining flanges across a common joining surface, the first tank shell and the second tank shell respectively being a multicomponent tank shell, which comprises a barrier film and at least on its edge area an inner wall section that is injection molded onto the inner side of the barrier film pointing toward the tank volume as well as an outer wall section injection molded onto the outer side of the barrier film pointing away from the tank volume.

### BACKGROUND OF THE INVENTION

Such a motor vehicle tank is known from DE 10 2017 119 706 A1. The tank shells of the known motor vehicle tank are a top shell and a bottom shell, which together bound the entire tank volume. To prevent a migration of chemicals outward through the tank shells out of the tank volume, the tank shells have a barrier film, which may be reinforced on both sides, that is, inside and outside, with injection molding material injected onto the barrier film. The injection molding material alone does not provide a sufficient migration barrier for certain chemicals such as hydrocarbons diffusing out of fuel for example. The barrier foil alone does not provide an enduring sufficient stability and is vulnerable to outside influences.

A further motor vehicle tank is known from DE 10 2017 119 708 A1, in which the top tank shell and the bottom tank shell are respectively formed from a barrier film that is reinforced only on one side with injection molding material. The barrier film in this case is situated on the bottom tank shell on the inner side facing the tank volume, so that the injection molded outer wall situated outside of the barrier film is able to protect the barrier film against rock impact etc. On the top tank shell of the known motor vehicle tank, deviating from the bottom tank shell, add-on parts and formed elements may be attached, in particular welded, to the injection molded inner wall, without having to disturb the barrier film for this purpose.

A further motor vehicle tank is known from DE 10 2016 214 059 A1, which has a sandwich structure made of an injection molded inner wall, and injection molded outer wall and an injection molded barrier layer situated between the inner wall and the outer wall in the direction of thickness. The tank shells of this fuel tank are formed by multicomponent injection molding processes.

The multicomponent injection molding process for forming a barrier layer between the injection molded inner and outer layers is difficult to perform in view of the layer thicknesses to be maintained and the layer thickness distribution along the tank shell surface area.

A tank shell having a completely exposed barrier film implies an increased risk of damage to the barrier film.

The tank shells known from DE 10 2017 119 706 A1, in which the barrier films respectively butt-end in the connecting surface of a joining flange, cannot always be readily joined so that the barrier films of the joined tank shells connect to each other in a continuous barrier wall. Compared to the lateral dimension of the associated joining flange, which is likewise to be measured from the tank volume to the outer side of the tank, the barrier film is thin, and, as plastic components, the tank shells are deformable, in particular under joining pressure. For this reason, when joining the two tank shells, the butt ends of the barrier films in the two tank shells do not always meet each other and join each other in the joining surface.

### SUMMARY OF THE INVENTION

Starting from the fuel tank mentioned at the outset, it is therefore an objective of the present invention to increase its tightness against chemicals, in particular hydrocarbons, migrating from the tank volume through the tank walls.

In a motor vehicle tank of the kind mentioned at the outset, the present invention achieves this objective in that the barrier film of each tank shell is formed in such a way that, as it approaches a joining surface developed for the joint with the respectively other tank shell, the barrier film runs away from the tank volume and in the direction of the outer side of the tank so that the integral joint of the tank shells is formed from a first joining area situated closer to the tank volume, in which the injection molded inner tank wall sections of the two tank shells are joined to each other, and a second joining area located further away from the tank volume, in which the barrier films of the two tank shells are joined to each other.

The barrier film is preferably inserted as a thermally deformed film into an injection molding tool, where injection molding material is injected onto its two sides. The injection of injection molding material on the inner side and/or on the outer side may be performed over the entire surface or only section-by-section. For reinforcing at least the joint, the barrier film is developed, at least in the edge area comprising the joining flange, both with an injection molded inner wall section as well as with an injection molded outer wall section. The barrier film, which extends across large parts of wall sections of the tank shell, normally in parallel to the exposed inner wall and/or outer wall of the tank shell, is formed in such a way that it extends away from the tank volume as it approaches the joining flange. This makes it possible to achieve two things: first, the barrier film may thus be guided into the joining surface at a low angle of approach so that it is able to extend in the joining surface in a lateral sense of the respective joining flange and the joint, to be measured from the tank volume to the outer side of the tank, over a dimension that significantly exceeds its mere material thickness. Second, the film on the joining flange may thus exit from the injection molded material at a further distance away from the tank volume and thus be accessible from the outer side of the tank for further processing.

Thus it is possible for the connecting surface sections of the inner wall sections of the tank shells, which meet each other in the joining surface between the two joining flanges of the tank shells, to be joined to each other in the first joining area located closer to the tank volume, and for the connecting area sections of the barrier films of the two tank shells to be joined to each other in the second joining area located further away from the tank volume. The joined area of the two joined barrier films may thus have a greater dimension in the direction from the tank volume to the outer side of the tank than the thickness of the barrier film, even many times the thickness of the barrier film.

To achieve a greatest possible first joining area, the barrier film when approaching the joining surface is further removed from the tank volume than the inner side of tank, which is formed by the inner tank wall section that is injection molded onto the inner side of the barrier film.

What is said in the present application about the motor vehicle tank also applies to a single tank shell of the same with the proviso that a connecting surface of the joining flange of the tank shell takes the place of the joining surface of the motor vehicle tank produced by the integral joining of the tank shells, that is, for example by adhesive bonding or preferably welding. In a position of the tank shell in which it is ready to be joined, in which the joining process has not yet occurred, but is about to occur, the connecting surface of the joining flange points toward and/or abuts against a connecting surface of the joining flange of the respective other tank shell to be joined. Through the joining process, the at first separate connecting surfaces of the joining flanges become a common joining surface producing the joint.

Hot plate welding is the preferably used welding technology. It is also possible, however, to join the tank shells by other welding methods such as hot gas welding, infrared welding, ultrasonic welding or friction welding methods.

The width of the joining surface section of the inner wall sections of the two tank shells may also be greater than the average thickness of the inner wall sections on the two tank shells. This makes it possible to achieve a high-strength joint between the tank shells, which ensures a secure joint also of the barrier films.

The barrier film in both tank shells preferably has a functional barrier layer made of EVOH (ethylene vinyl alcohol copolymer) and/or of PVOH (polyvinyl alcohol), which offer excellent resistance against hydrocarbons, as are contained in fuels for example, in particular in gasoline fuel. Via an adhesive agent layer, a connecting layer made of a thermoplastic may be situated on both sides of the functional barrier layer, which is compatible with the injection molding material of the inner wall section and of the outer wall section, respectively. For example, an HDPE layer may be attached as the connecting layer on both sides of the functional barrier layer, in which case LDPE or LLDPE may be situated as the adhesive agent between the HDPE layer and the functional barrier layer. A polyolefin, preferably a polyethylene, particularly preferably HDPE, may then be injection molded onto the HDPE layer with excellent adhesion.

On account of the described barrier effect of EVOH and/or PVOH, the motor vehicle tank according to the invention is preferably a fuel tank, particularly preferably a gasoline tank.

In the sense of the present invention, joining the barrier film implies a joining of at least respectively one layer of the barrier film from different tank shells to one another. Thus, a joining of the barrier layer may already be achieved in that the outer connecting layers of two barrier layers are integrally joined to each other. In this case, the functional barrier layers of the two barrier films are brought very close to each other or possible even touch each other. Since the material of the adhesive agent layers is often compatible with the material of the connecting layers, the barrier films may also be joined by joining the adhesive agent layers and the connecting layers of barrier films of different tank shells. In this case, the second joining area may comprise a mixture of the materials of the adhesive agent layers and of the connecting layers or, depending on the angle of the approach of the two barrier films to each other, a first partial area of an integral connection of the connecting layers and a second partial area of an integral connection of the adhesive agent layers.

Fundamentally, the aim is to fuse also the functional barrier layers directly to each other. Normally, the melting temperature of the functional barrier layer is higher than the melting temperature of the adhesive agent layers and/or the connecting layers. In the aforementioned material example of a preferred barrier film, the melting temperature of EVOH is approximately 40 K higher than the melting temperature of the HDPE of the connecting layer. The second joining area preferably comprises an integral connection of the functional barrier layers. Since at a joining temperature, at which the functional barrier layers a thermally softened, the adhesive agent layers and the connecting layers are also softened or melted, the second joining area may comprise a zone of an integral connection made of a mixture of the materials of at least two layers of the functional barrier layer, the adhesive agent layer and the connecting layer or of all three of these layers.

The material of the inner wall section and/or the material of the outer wall section may be unreinforced injection molding material or, for increased strength, reinforced injection molding material, for example injection molding material reinforced with fibers and/or particles. The injection molding material may also contain recycled material. It is also conceivable to use MuCell® technology for injection molding the outer wall section and/or the inner wall section in order to obtain greater thickness differences between the outer wall section and the inner wall section and/or in order to work with lower injection pressures. Ultimately, MuCell® technology is able to achieve a reduction in weight at a still sufficient component strength.

Although the fuel tank may comprise more than only two tank shells, the first tank shell is preferably a top tank shell comprising the tank ceiling as top side of the tank and/or the second tank shell is preferably a bottom tank shell comprising the tank bottom as a bottom side of the tank. It shall not be precluded, however, that a tank shell made up of a first tank shell and a second tank shell is a lateral tank part, which has two joining flanges connected by a tank wall section, each of which is joined to a further tank shell.

To facilitate the joining process of the first and second joining areas, it is preferred if the first and second joining areas lie in a common joining plane. The joining process of the first joining area and of the second joining area, that is, the establishment of the joining areas by joining the connecting surface sections lying opposite each other across an initial joining gap, of the inner wall sections and, respectively, of the barrier films of the two joining flanges to be joined, may then be performed in a particularly simple manner by welding technology. The joint may then be produced in a manner known per se simply and reliably by hot plate welding using a plane welding plate.

In principle, it may be sufficient if only the inner wall sections and the barrier films of the two tank shells are joined to each other, so that the injection molded outer wall sections of the first and second tank shells may be situated at least along a joining section around the tank volume spatially distanced from each other by the barrier film. The outer wall sections of the two tank shells may converge toward the joint, without themselves being directly integrally joined to each other. The outer wall sections may outwardly cover the barrier film in the area of the joint and thus protect it against external influences in the particularly sensitive flange area, which normally protrudes on the motor vehicle tank in the direction away from the tank volume.

In order to prevent the sectionally exposed barrier film, in particular the functional barrier layer, from absorbing moisture, which may cause a delamination of the barrier film, it is advantageous to shield the barrier film also toward the external surroundings of the motor vehicle tank. A protection of the barrier film even in the area of the joint may be obtained for example in that the integral joint has a third joining area situated further removed from the tank volume than the second joining area, in which the injection molded outer tank wall sections of the two tank shells are joined to each other. The barrier films of the two tank shells may then form a continuous barrier casing bridging the joint, which is inwardly shielded toward the tank volume by a continuous inner wall casing made of injection molded, joined inner wall sections and which is shielded outwardly toward the outer side of the tank by a continuous outer wall casing made of injection molded, joined outer wall sections.

The extent of the third joining area in the lateral sense from the tank volume to the outer side of the tank is preferably shorter than the extent of the first joining area, and preferably also shorter than the extent of the second joining area. The lateral extent of the second joining area may be shorter than the extent of the first joining area, which preferably provides the greatest share of the strength of the joint.

The aforementioned development of the barrier film in the area, in which it approaches the connecting surface of its joining flange, makes it possible, following the joining of the first tank shell and the second tank shell to each other, for the second joining area to shield the first joining area radially outwardly at least along a joining section around the tank volume. The inner wall section may thus be situated entirely within a closed casing formed by the barrier film. Likewise, when the third joining area is formed, it is able to shield the second joining area radially outwardly at least along a joining section around the tank volume. Preferably, the two mentioned joining sections are one and the same joining section so that the third joining section shields radially outwardly not only the second, but also the first joining area and, respectively, that the first joining section shields radially inward not only the second, but also the third joining section.

A simple and secure connection of the two barrier films of the first tank shell and of the second tank shell to each other with a sufficiently large areal extension of the second joining area may be obtained in that the barrier film is designed to be convexly curved in the area of the joining or connecting surface, when viewing the barrier film, or the connecting surface, of the one tank shell from the respectively other tank shell, the convexly curved area forming the second joining area. Depending on the design of the curvature, the joining surface of the second joining area may be enlarged or reduced. An enlargement of the radius of curvature of the convex curvature enlarges the joining surface area, a reduction of the radius of curvature reduces it. The convexly curved arrangement of the barrier film in the second joining area allows for a simple compensation of a possibly existing lateral offset of the two tank shells to be joined, for example due to thermal warping following the release from the injection mold or due to deformation under load during the joining process.

The convex curvature—when viewed from the respectively other joining flange—of the barrier film in the area of the joining or connecting surface may result in a groove-shaped formation of the barrier film in the area of the connecting surface, since the side of the barrier film opposite to the convexly curved side is concavely curved. Such a groove-shaped formation of the barrier film and, if applicable, also of the outer wall section possibly injection molded on the concave side may facilitate the targeted application of a joining pressure onto the barrier film in the direction of the respectively other joining flange as the joining partner.

Although the joining flanges of the first and of the second tank shell may be developed differently, for producing a reliable joint, in particular by the preferred hot plate welding, it is preferred if the joining flanges are developed in mirror symmetry at least beginning with the common joining surface.

Furthermore, it is conceivable that on at least one of the two tank shells, prior to joining, at least one injection molded wall section, made up of the inner wall section and the outer wall section, protrudes or is recessed at least in sections in the joining direction with respect to a connecting surface section formed by the barrier film, so that during the joining process at least a section of an injection molded wall section is melted more or melted less than the barrier film.

In order to achieve the goal that the barrier film moves away from the tank volume as it approaches the connecting surface, the barrier film—when viewing a tank shell from outside toward the tank volume—may be concavely curved and/or flat and inclined at least in sections toward the joining or connecting surface. The concave curvature away from the tank volume in particular ensures a preferably kink-free approach of the barrier to the joining surface of the tank or to the connecting surface of the joining flange of its tank shell.

The described curvature or inclination makes it possible to ensure that the barrier film together with the joining or connecting surface encloses an angle of no more than 80°. As a result, the barrier film no longer butts straight into the joining or connecting surface, but approaches the latter in inclined fashion or even tangentially. Even at the mentioned 80°, that is, at an orientation inclined by approximately 10° with respect to an orthogonal emergence of the barrier film in the connecting surface or joining surface, the abutting surface of the barrier film exposed in the connecting surface and available for joining to another barrier film is advantageously enlarged compared to an orthogonal emergence of the barrier film into the connecting surface. Thus, a larger available surface area of the barrier films lie across from one another in the connecting surface so that even in the event of a thermal warping of the injection molded tank wall sections of the inner wall section and the outer wall section, or in an error-tolerant approach of the tank shells toward each other, there exists a sufficient probability of overlap of barrier film surfaces when joining. In this sense, diminishing angles between the barrier film and the joining or connecting surface of no more than 70°, preferably of no more than 60° or even of no more than 50° may offer further advantages with regard to an enlargement of the surface areas of the barrier films lying opposite each other prior to the joining process.

In the lateral sense of the ring-shaped or partial ring-shaped joining surface or connecting surface, the barrier film reaches, at least in circumferential sections, preferably along the entire circumference of the motor vehicle tank or a tank shell, the joining surface or connecting surface preferably in the 50%, preferably 25%, particularly preferably 10% of the lateral extent of the joining surface or connecting surface located radially further outside.

It is likewise conceivable that the barrier film emerges from an end face of the joining flange of a tank shell facing away from the tank volume at a distance from the joining surface or connecting surface, and that the barrier films of the two tank shells are joined—relative to the enclosed tank volume—outside of the joining flange.

In principle, the second joining area may therefore be exposed in such a way that a barrier joining section formed only from joined barrier films of the two tank shells is accessible from opposite sides of the section.

Although for achieving the advantages according to the invention described above it suffices if the joint between the first tank shell and the second tank shell extends only along a section around the tank volume, for achieving a tank that is as tight and strong as possible, the joint between the first tank shell and the second tank shell preferably runs in a closed circle around the tank volume.

The motor vehicle tank preferably has no further tank shell beyond the mentioned first and second tank shells. One of the tank shells, in fuel tanks in particular the upper tank shell, may have an opening for receiving a functional module, which supports at least one functional component for operating the motor vehicle tank and which is insertable or is inserted into the opening. The functional component may be a level meter and/or a feed pump and/or a temperature sensor and/or a filter for cleaning the liquid accommodated in the tank.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 a perspective longitudinal sectional view through a first specific embodiment of a motor vehicle tank according to the invention,

FIG. 2 the motor vehicle tank of FIG. 1 in a longitudinal sectional elevation,

FIG. 3 a second specific embodiment of a tension anchor in the interior of the motor vehicle tank,

FIG. 4 a third specific embodiment of a tension anchor in the interior of the motor vehicle tank,

FIG. 5A a detailed longitudinal sectional view of a joint of the tank shells forming the motor vehicle tank of FIG. 1 in a position of readiness prior to joining,

FIG. 5B a longitudinal sectional view of the joint of FIG. 5A following the establishment of the joint,

FIG. 5C a longitudinal sectional view of the joint of FIG. 5B following a flush trimming of the joined barrier films on the end faces of the joining flanges,

FIG. 6 a longitudinal sectional view of a joint of a second specific embodiment according to the invention of a motor vehicle tank having a divergent shape of the joint,

FIG. 7 a longitudinal sectional view of a joint of a third specific embodiment according to the invention of a motor vehicle tank having a divergent shape of the joint, and

FIG. 8 a longitudinal sectional view of a joint of a fourth specific embodiment according to the invention of a motor vehicle tank having a divergent shape of the joint.

### DESCRIPTION OF PREFERRED EMBODIMENTS

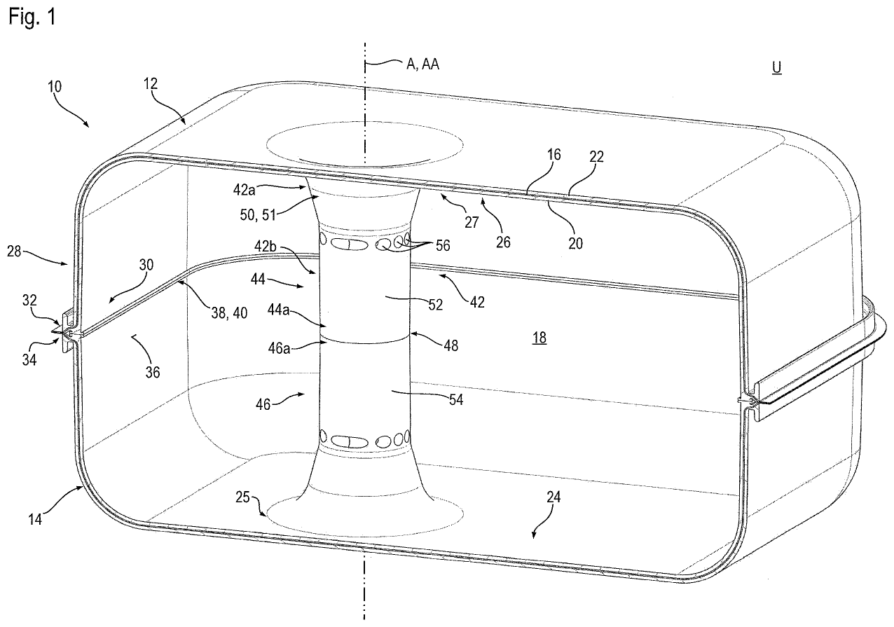

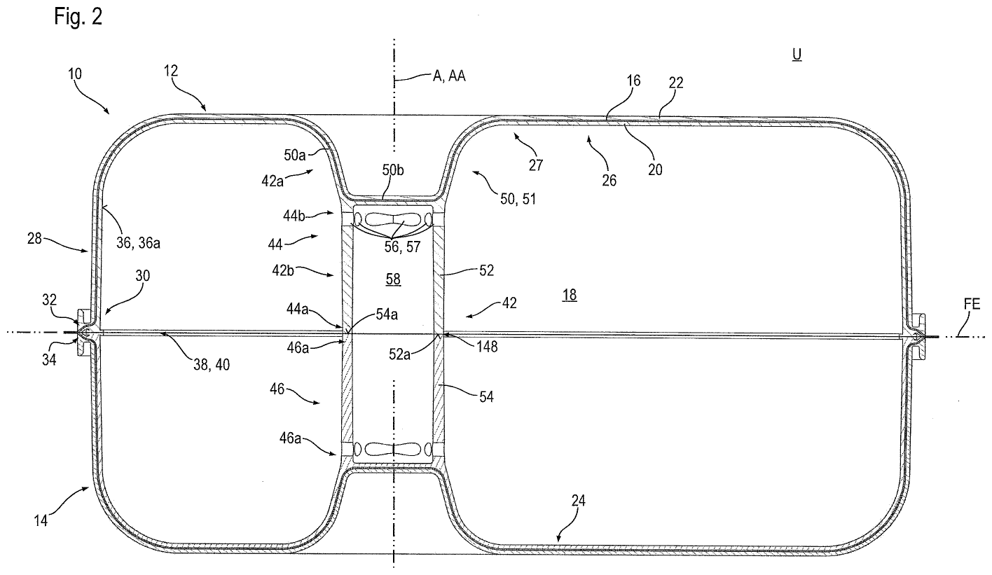

Referring now to the drawings wherein the showings are for the purpose of illustrating preferred and alternative embodiments of the invention only and not for the purpose of limiting the same, FIGS. 1 and 2 show a first specific embodiment according to the invention of a motor vehicle tank in a perspective sectional view (FIG. 1) and in a sectional elevation (FIG. 2) in a rough schematic manner, generally designated by 10. Motor vehicle tank 10, which is preferably a gasoline tank, comprises an upper tank shell 12 as the first tank shell and a lower tank shell 14 as the second tank shell.

Both the upper tank shell 12 as well as the lower tank shell 14 are respectively three-layer tank shells, comprising a middle barrier film 16, an inner wall 20 facing the tank volume 18, which is injection molded onto barrier film 16, and an outer wall 22 injection molded onto barrier film 16 on the side facing away from tank volume 18 and toward the external surroundings of the tank U.

The upper tank shell 12 and the lower tank shell 14 are joined to each other along a common joining plane FE by hot plate welding. The tank shells shown in the figures, that is, upper tank shell 12 and lower tank shell 14, are developed in mirror symmetry with respect to joining plane FE at least in the sections shown, which is why, taking account of the described mirror symmetry, the description of upper tank shell 12 is also applicable as the description of lower tank shell 14.

In point of fact, it is not necessary for upper tank shell 12 and lower tank shell 14 to be developed in mirror symmetry or to be developed completely in mirror symmetry, and normally they are not, since for example at least one functional module may be situated in upper tank shell 14, in the area of a tank ceiling 26, which is used to withdraw liquid, in particular gasoline, accommodated in tank 10, and or to ascertain the level of liquid in tank 10.

Hence, only upper tank shell 12 will be described below, the description standing for both tank shells 12 and 14.

Upper tank shell 12 has tank sealing 26, which is situated diametrically opposite from a tank bottom 24 across tank volume 18. Statements that with regard to upper tank shell 12 concern tank ceiling 26 or refer to tank ceiling 26 also apply to lower tank shell 14 with the proviso that by application of the aforementioned mirror symmetry condition they concern tank bottom 24 or refer to tank bottom 24.

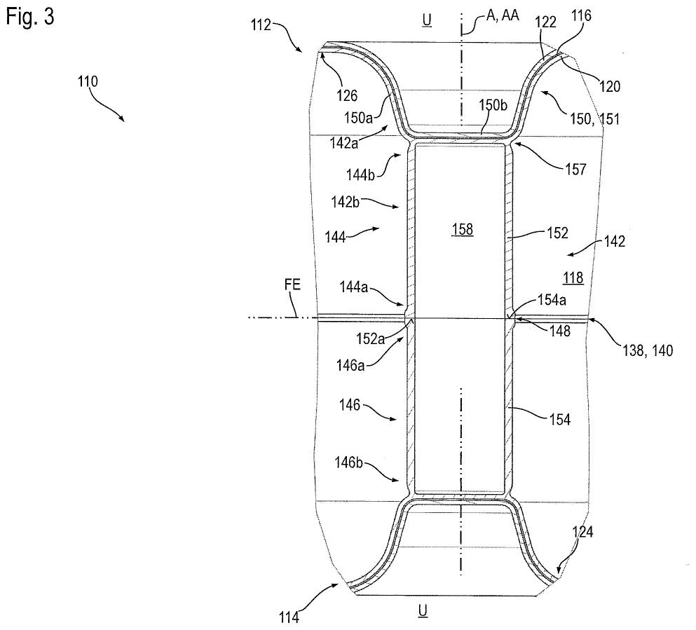

A circumferential lateral wall section 28 connected in one piece with tank ceiling 26 extends from tank ceiling 26 toward lower tank shell 14. At its distal edge area 30 away from tank ceiling 26, lateral wall section 28 has a completely closed joining flange 32 running circumferentially around tank volume 18. Joining flange 32 of upper tank shell 12 is integrally joined to joining flange 34 of lower tank shell 14, preferably by the hot plate welding process already mentioned above. A welding bead 38 produced by the hot plate welding process on the inner tank side 36 indicates the course of the joint 40 between the upper tank shell 12 and the lower tank shell 14. Joint 40 will be described in more detail further below in connection with FIGS. 3 through 5, in which the mutually joined joining flanges 32 and 34 are shown in an enlarged manner.

Due to fuel vapors forming in tank volume 18 of motor vehicle tank 10 for example, the pressure prevailing in tank volume 18 may change considerably in terms of its absolute value in the course of the operational life of motor vehicle tank 10. This occurs particularly in plug-in hybrids, in which the internal combustion engine may remain deactivated for longer periods in driving operation. In the external surroundings U of tank 10, ambient conditions normally prevail, that is, an atmospheric pressure in the order of magnitude of approximately 1000 hPa.

In order to avoid deformations of tank shells 12 and 14 due to pressure differences between an increased pressure in tank volume 18 and a comparatively lower pressure in terms of absolute value in the external surroundings U of the tank, tension anchors 42 are formed on tank shells 12 and 14, which run between tank ceiling 26 and tank bottom 24 or generally between opposite tank wall sections 25 and 27.

Such a tension anchor 42 is formed in the present example by an upper tension anchor part 44 and a lower tension anchor part 46. In the present example, the upper tension anchor part 44 and the lower tension anchor part 46 are developed for the sake of simplicity in mirror symmetry with respect to the joining plane FE as the mirror symmetry plane. Again, it therefore suffices to describe only one formation of the two parts of upper tension anchor part 44 and lower tension anchor part 46. In consideration of the mentioned symmetry condition, the description also applies to the respectively other formation.

In the exemplary embodiment shown, upper tension anchor part 44 and lower tension anchor part 46 are developed to be essentially rotationally symmetric with respect to a tension anchor axis A that is orthogonal to joining plane FE. Tension anchor axis A is also protuberance axis AA, along which protuberance 51 protrudes with respect to the tank wall area 27 that surrounds it. Protuberance 51 is in the present case rotationally symmetric with respect to protuberance axis AA. This is not necessarily so, as instead of a rotationally symmetric development, tension anchor 42 and/or protuberance 51 may also be bounded polyhedrally or irregularly or may be formed by braces in a lattice-like manner.

Upper tension anchor part 44 and lower tension anchor part 46 are integrally connected to each other at their mutually facing longitudinal end areas 44a and 46a. The integral connection of upper tension anchor part 44 and lower tension anchor part 46 is preferably produced in the same hot plate welding process, in which joining flanges 32 and 34 are also connected to each other. For this reason, joint 48 of upper tension anchor part 44 and lower tension anchor part 46 is also situated in joining plane FE.

FIG. 2 shows motor vehicle tank 10 in rough schematic fashion in a longitudinal sectional elevation, joining plane FE being oriented orthogonally to the drawing plane of FIG. 2. The sectional plane of FIG. 2 contains anchor axis A.

In the area of a tension anchor base 42a of upper tension anchor part 44, barrier film 16 is recessed as a protuberance 51 forming an indentation 50 in the direction toward tank volume 18, that is, in the direction toward joining flange 32 or toward joining plane FE of upper tank shell 12 bearing upper tension anchor part 44. The indentation 50 of barrier film 16 advantageously tapering toward joining plane FE was developed by thermoforming prior to injection molding the inner tank wall 22 and outer tank wall 22 onto barrier film 16.

Prior to insertion into an injection mold, barrier film 16 is formed into its shape essentially shown in FIGS. 1 and 2 and maintains this shape. Barrier film 16 is thus inherently stable, i.e., it essentially maintains its shape under the influence of its own weight and does not deform plastically.

The indentation 50 of barrier film 16 is formed by a jacket section 50a tapering toward joining plane FE and by a preferably flat cover section 50b covering jacket section 50a. Indentation 50, which is connected in one piece with the rest of barrier film 16, is continuous and thus forms also in the area of tension anchor 42 or tension anchor base 42a a migration barrier for hydrocarbons of the fuel accommodated in motor vehicle tank 10, shielding tank volume 18 toward external surroundings U.

In the area of cover section 50a, on its side facing joining plane FE, a tension anchor substructure 52 is formed as a tension anchor section 42b projecting from tension anchor base 42a toward the opposite tank wall area 27. End face 52a of tension anchor substructure 52, pointing away from indentation 50, is designed and situated for being welded to an opposite end face 54a of a tension anchor substructure 54 of lower tension anchor part 46.

Perforations 56 in tension anchor substructure 52 of upper tension anchor part 44 allow for a pressure equalization between tank volume 18 and the interior 58 of tension anchor 42. To achieve a lowest possible weight, tension anchor substructures 52 and 54 are hollow on the inside. Perforations 56 thus also make it possible to use the interior of tension anchor 42 for storing liquid, so that the formation of tension anchor 42 reduces the storage volume in tank volume 18 essentially only by the wall thickness of tension anchor substructures 52 and 54. Furthermore, the perforations can also act as predetermined breaking points 57 to prevent tension anchor 42 from destructively and undesirably opening tank 10 in the event of a vehicle collision, for example.

Developing upper tension anchor part 44 so that it connects to and projects from indentation 50 of barrier film 16, which has inner tank wall 20 injection molded onto it, makes it possible to design upper tension anchor part 44 to be shorter or to have a shorter projection length from tank ceiling 26 and/or a thinner wall thickness and yet be comparatively easily removed from the injection mold, compared to a longer projection length of upper tension anchor part 44. This makes it possible to produce upper tension anchor part 44 with high mechanical strength and complex geometry by injection molding, either in a separate injection molding or assembly step onto inner tank wall 20 or, preferably, in one injection molding step together with injection molding inner tank wall 20 onto barrier film 16.

Just like the tension anchor 42 illustrated in FIGS. 1 and 2, it is also possible, using the thermoplastic injection molded outside or inside, to produce reinforcement ribs by injection molding on inner tank wall 20 or on outer tank wall 22, namely, preferably at the same time as the injection molding of the respective wall 20 and 22 onto barrier film 16.

Instead of an indentation 50, it is possible in the same manner to produce a bulge projecting from a tank shell 12 and/or 14 away from tank volume 18. If necessary, this bulge may be open at its projecting longitudinal end and may then be developed as a connector for connecting a fluid line.

When forming barrier film 16 into indentations 50 and/or into bulges projecting in the opposite direction, undercut formations may be developed on jacket surfaces 50a, for example having a wave, zigzag, sawtooth and/or fir tree contour, which ensure an even more solid anchoring of the partial tank wall injection molded onto the jacket surface.

FIG. 3 illustrates a second specific embodiment of a motor vehicle tank having a tension anchor. Components and component sections identical and functionally identical to those in the first specific embodiment are labeled in the second specific embodiment with the same reference numerals, but incremented by the number 100.

The second specific embodiment of the motor vehicle tank and essentially of the tension anchor is described subsequently only to the extent that it differs from the first specific embodiment of FIGS. 1 and 2, their explanation otherwise also being referenced for the explanation of the specific embodiment of FIG. 3.

The tension anchor 142 of the second specific embodiment is also roughly cylindrical like the tension anchor 42 of the first specific embodiment. In contrast to the first specific embodiment, tension anchor 142 has no perforations so that its interior 158 is completely shielded from tank volume 118 by the wall of tension anchor substructures 152 and 154. This is illustrated only by way of example, however. Tension anchor 142 may also have perforations in its wall, which connect its interior 158 with tank volume 118.

In the area of its longitudinal ends 144b and 146b of upper tension anchor part 144 and of lower tension anchor part 146, respectively, near the respective indentations 150, tension anchor 142 has a circumferential thin material point as a predetermined failure formation or predetermined breaking point 157. In the event that a tensile load acting along anchor axis A exceeds a predetermined threshold value in terms of absolute value, tension anchor 142 ruptures at predetermined breaking point 157, so that the tension anchor cannot transmit any loads exceeding the failure threshold value between the opposite tank wall sections 125 and 124 connected by tension anchor 142, which otherwise, for example in the event of an accident of the vehicle carrying tank 110, could result in an unwanted opening of tank 110.

The thin material point as predetermined breaking point 157 is produced by slides when producing the tension anchor parts of upper tension anchor part 144 and lower tension anchor part 146 by injection molding.

Tension anchor 142 has a circumferential broadening at the mutually facing longitudinal ends 144a and 146a of upper tension anchor part 144 and lower tension anchor part 146, respectively, so that end faces 152a and 154a have a greater surface area than a sectional area of tension anchor 142 along a sectional plane orthogonal to anchor axis A between the broadening and predetermined breaking point 157. This makes it possible to obtain a tension anchor 142 having a low weight and at the same time a sufficiently high joining strength in joining area 148 between end faces 152a and 154a.

The illustrated broadening with enlarged end faces may of course also be implemented in another specific embodiment of a tension anchor presented in the present application.

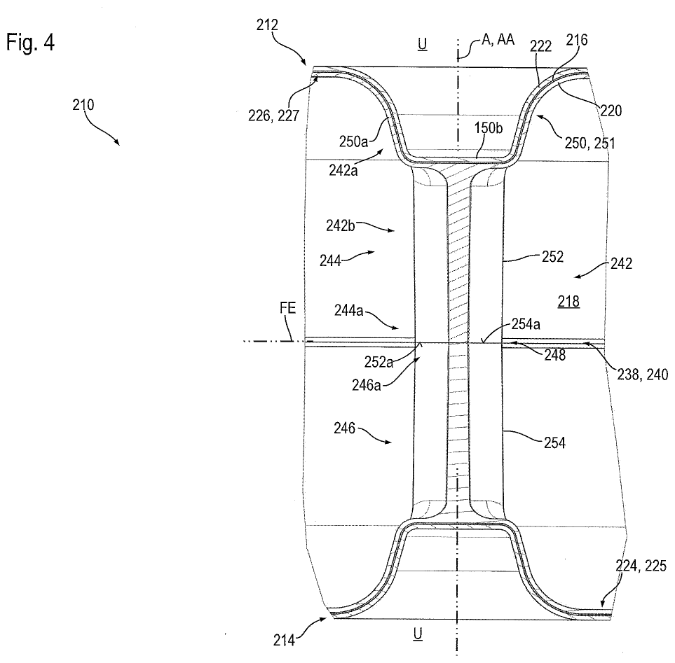

FIG. 4 illustrates a third specific embodiment of a motor vehicle tank having a tension anchor. Components and component sections identical and functionally identical to those in the first and second specific embodiments are labeled in the third specific embodiment with the same reference numerals, but in the number range from 200 to 299. The third specific embodiment of the motor vehicle tank and essentially of the tension anchor is described subsequently only to the extent that it differs from the first two specific embodiments, their explanation otherwise also being referenced for the explanation of the specific embodiment of FIG. 4.

Tension anchor 242 is not hollow and not rotationally symmetric. It extends along anchor axis A with an essentially uniform cross-ribbed cross section. As a cross rib, tension anchor 242 is particularly stiff, in particular flexurally stiff. The loss of volume incurred by the formation of tension anchor 242 in tank volume 218 is very small. A predetermined breaking point is not developed in the illustrated example. It may be developed for example in the area of joint 248 of the two tension anchor parts, that is, the upper tension anchor part 240 and the lower tension anchor part 244. One possibility for developing a predetermined breaking point on tension anchor 242 having a cross-ribbed cross section is to taper upper tension anchor part 244 and/or lower tension anchor part 246 toward the respective end face 252a and 254a.

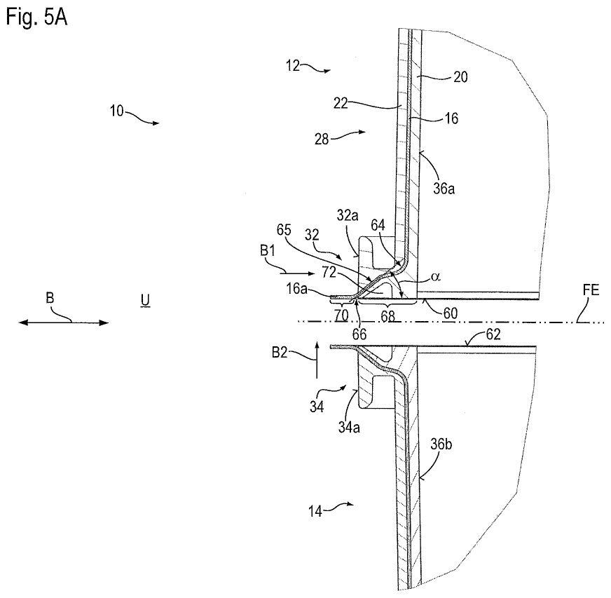

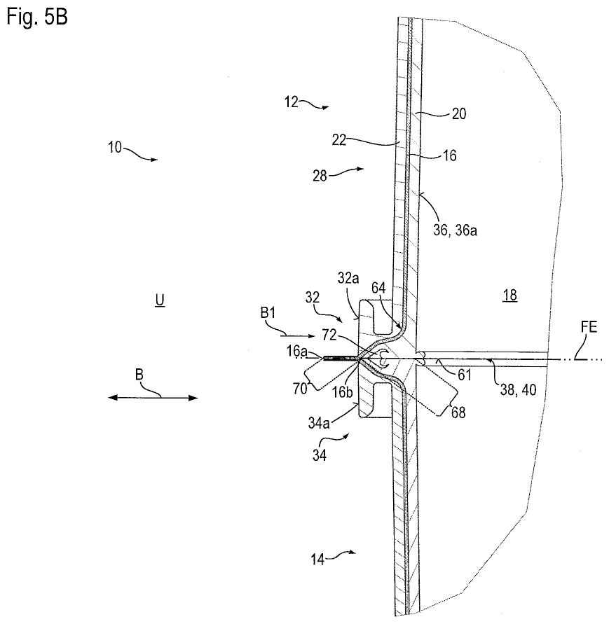

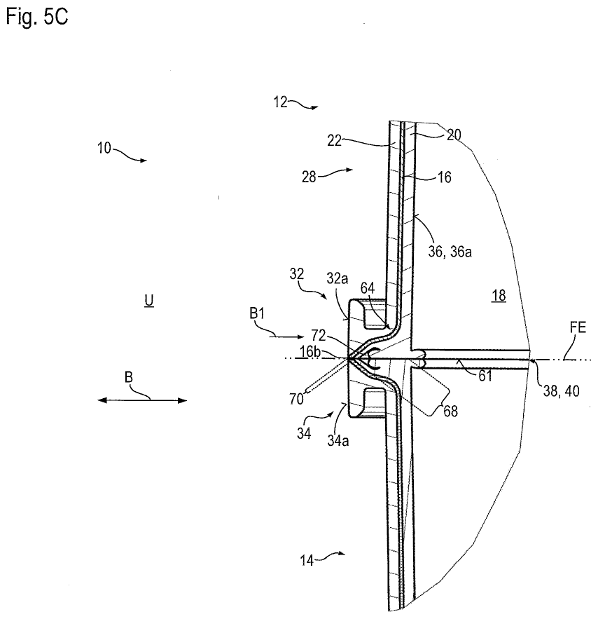

FIG. 5A, which refers to the first specific embodiment, illustrates joining flanges 32 and 34 prior to the integral connection. On its side facing joining flange 34 of lower tank shell 14, joining flange 32 of upper tank shell 12 has a connecting surface 60, which comes into contact with the opposite connecting surface 62 of joining flange 34 during the joining process.

In the area of lateral wall section 28 and in the area of tank ceiling 26, the injection molded inner tank wall 20 has approximately the same thickness as the injection molded outer tank wall 22 in the illustrated example. However, this need not be so. On the one hand, it is possible that locally no injection molded material is injection molded onto one side or onto both sides of the barrier film, and therefore inner tank wall 20 and/or outer tank wall 22 may be locally omitted. On the other hand, the inner tank wall 20 may be developed to be locally thicker and/or thinner than outer tank wall 22 in the same location.

In the area of lateral wall section 28, barrier film 16 follows the course of inner side 36a of upper tank shell 12, which forms inner tank side 36 upon joining.

In approaching connecting surface 60, however, barrier film 16 runs in the direction away from tank volume 18 and toward external surroundings U of tank 10, and it does so in a more pronounced way than inner side 36 of tank 10.

Barrier film 16, preferably a multilayer layer structure made up of a central EVOH layer, of adhesive agent layers of LDPE applied on both sides of the EVOH layer, and of outer connecting layers of HDPE in turn applied on adhesive agent layers LDPE, is itself advantageously formed from thermoplastic material and is thus thermally joinable. In the illustrated example, the injection molded inner tank wall 20 and the injection molded outer tank wall 22 are made of HDPE or comprise HDPE.

Due to the described course of barrier film 16, not only toward connecting surface 60, but at the same time also away from tank volume 18, barrier film 16 on the one hand does not emerge butt-ended from connecting surface 60, but approaches it at an enclosed angle α of approximately 40°, by way of example. As a result, it reaches connecting surface 60 on the one hand without kinking and on the other hand reaches connecting surface 60 at such a distance from tank volume 18 that barrier film 16 in the area of connecting surface 60 is accessible for further processing, in particular for a joining process.

When viewing upper tank shell 12 along viewing direction B1 from outside in the direction toward tank volume 18, barrier film 16 is concavely curved in area 64, the concavely curved area encircling tank volume 18. The concavely curved area 64 may be followed by a sectionally flat inclined area 65.

When viewed along viewing direction B2 from lower tank shell 14, barrier film 16 is curved convexly in area 66.

Barrier film 16 emerges from joining flange 32 on an end face 32a of joining flange 32 facing away from tank volume 18. During the joining process, the two joining flanges 32 and 34 are drawn near each other by partially melting their connecting surfaces 60, so that the sections of barrier films 16 outside of joining flanges 32 and 34 are also drawn near each other. A joining section 16a of barrier film 16 thus lies outside of joining flange 32, namely, radially outside joining flange 32 relative to tank volume 18. A further joining section 16b of barrier film 16 (see FIG. 5B), which is considerably shorter than joining section 16a in the lateral sense B, is therefore situated within joined joining flanges 32 and 34.

When joining the upper tank shell 12 with the lower tank shell 14, a first joining area 68 is thus created in the area of joining flange 32, which is situated radially further inward, that is, closer to tank volume 18 and in which only material of injection molded inner tank wall 20 is joined, and a second joining area 70 is created, in which the barrier films 16 of upper tank shell 12 and of lower tank shell 14 are joined, the second joining area 70 being situated further removed from tank volume 18 than first joining area 68. Second joining area 70 thus shields first joining area 68 with respect to the external surroundings U of tank 10, and first joining area 68 shields second joining area 70 with respect to tank volume 18.

On account of a circumferential depression 72, first joining area 68 is formed in two parts, having a wider part situated closer to tank volume 18 and a narrower part situated further removed from tank volume 18. Depression 72 runs in the lateral sense of connecting surface 60 between the aforementioned parts of first joining area 68.

FIG. 5B shows the two tank shells 12 and 14 of FIG. 5A after they have been joined to form tank 10. First joining area 68 and second joining area 70 have been produced. These two joining areas 68 and 70 are labeled by way of dotted lines obliquely drawn out of joined joining flanges 32 and 34 merely for the sake of better clarity. As a result of the joining process, connecting surfaces 60 of the two tank shells 12 and 14 have now become a common joining surface 61.

Welding bead 38 in first joining area 68 was formed both into tank volume 18 as well as into depression 72, so that material of inner tank wall 20 displaced during the welding process does not interfere with second joining area 70. Since the part of first joining area 68 situated further removed from tank volume 18, beyond depression 72, has only a comparatively small joining surface, only a little material is displaced in this area.

Barrier film 16, which emerges at the end faces 32a and 34a of the respective joining flanges 32 and 34, physically separates inner tank wall 20 from outer tank wall 22, so that the outer tank walls 22 of the two tank shells 12 and 14 in the area of joining flanges 32 and 34 are only indirectly connected to each other via barrier film 16 and inner tank walls 20, but not directly connected to each other.

FIG. 5C shows a further processing of tank 10 of FIG. 5B, after the part of barrier film 16 protruding outwardly beyond end faces 32a and 34a toward external surroundings U, that is, the joining section 16a situated outside of joining flanges 32 and 34, was cut off flush with end faces 32a and 34a. Only the, in the lateral sense B, short joining section 16b situated within joining flanges 32 and 34 remains on tank 10.

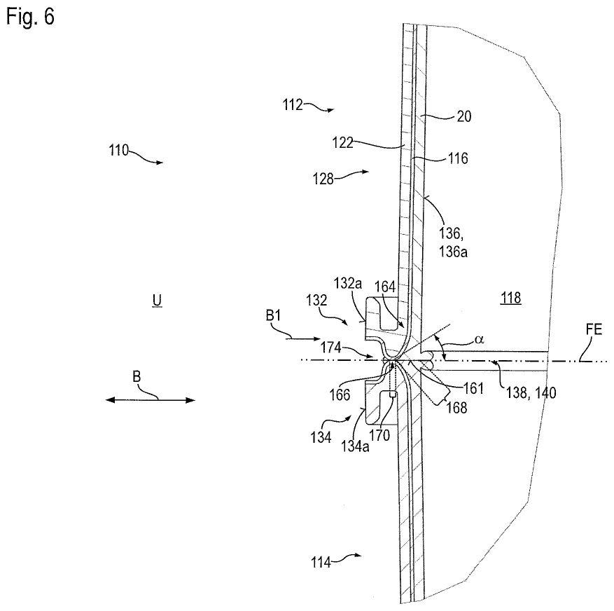

FIG. 6 shows again the second specific embodiment of a motor vehicle tank of the present invention, although this time only in connection with the joining situation at the joining flanges. Components and component sections identical and functionally identical to those in the first specific embodiment of FIGS. 1 through 4 are labeled in FIG. 6 with the same reference numerals, but incremented by the number 100. The second specific embodiment of FIG. 6 is explained only to the extent that it differs from the first specific embodiment of FIGS. 1, 2 and 5A through 5C, their explanation otherwise also being referenced for the description of the specific embodiment of FIG. 6.

It is further pointed out that the design of a particular tension anchor in the motor vehicle tank is independent of the design of a joint at the joining flanges.

In the specific embodiment of FIG. 6, the section 164 of barrier film 116, which is concave from the viewing direction B1 and which has the effect that barrier film 116 moves away from tank volume 118 without kinking as it approaches joining flange 132, transitions into section 166, which is convex from viewing direction B2 and which forms the section of connecting surface 60 that constitutes second joining area 170.

In second joining area 170, barrier film 116 is formed to be U-shaped, that is, groove-shaped, in its longitudinal section, so that barrier foil 116 runs on both sides of joining area 170 away from joining surface 161 or from joining plane FE. Outer tank walls 122 are again not directly connected to each other.

In the section of joining flanges 132 and 134 situated radially outside, that is, further removed from tank volume 118 than second joining area 170, an at least partially, preferably completely, circumferential depression 174 is formed, which may be used as a handle or for applying a handling or transport tool for handling or for transporting motor vehicle tank 110.

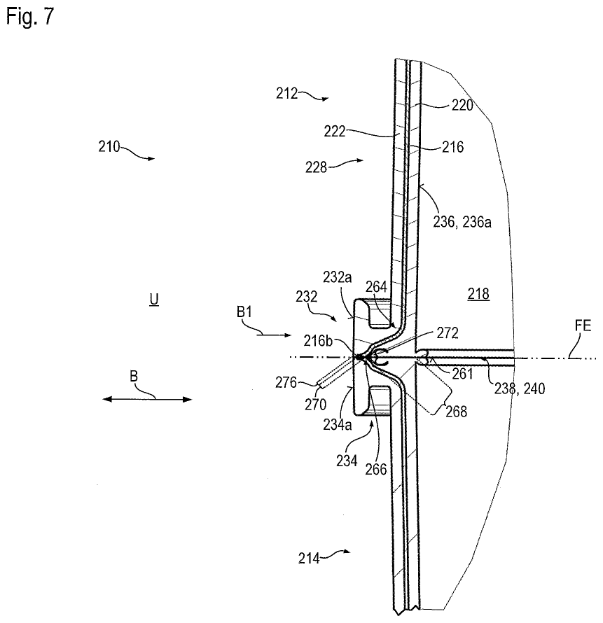

FIG. 7 shows again the third specific embodiment of a motor vehicle tank of the present invention, again only in connection with the joining situation at the joining flanges. Components and component sections identical and functionally identical to those in the first and in the second specific embodiments of FIGS. 1, 2 and 5A through 6 are labeled in FIG. 7 with the same reference numerals, but in the number range from 200 to 299. The third specific embodiment of FIG. 7 is explained only to the extent that it differs from the first and the second specific embodiments of FIGS. 1, 2 and 5A through 6, their explanation otherwise also being referenced for the description of the third specific embodiment of FIG. 7.

The third specific embodiment of FIG. 7 essentially corresponds to the second specific embodiment of FIG. 5C with the difference that outer wall sections 222 are extended at joining flanges 232 and 234 radially outward toward the external surroundings so that they form a third joining area 276 when joining tank shells 212 and 214, which is further removed from tank volume 218 than second joining area 270 of barrier films 216. Third joining area 276 thus shields second joining area 270 with respect to external surroundings U, and, as before, first joining area 268 shields second joining area 270 with respect to tank volume 118.

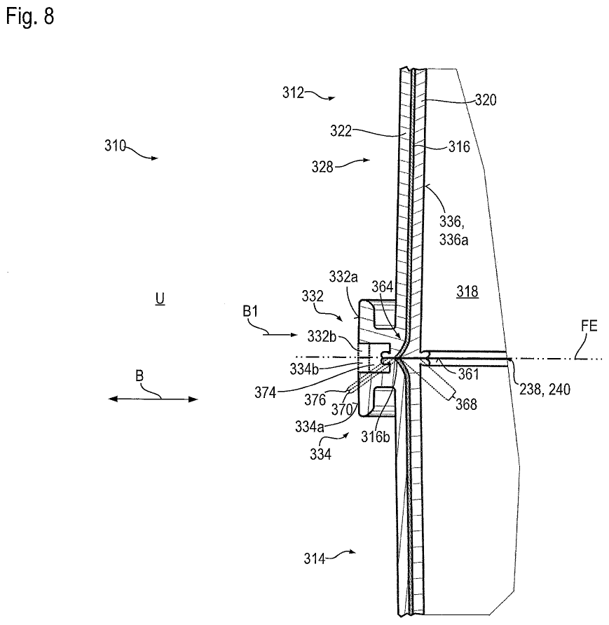

FIG. 8 shows a fourth specific embodiment of a motor vehicle tank of the present invention, again only in connection with the joining situation at the joining flanges. Components and component sections identical and functionally identical to those in the first through third specific embodiments of FIGS. 1, 2 and 5A through 7 are labeled in FIG. 8 with the same reference numerals, but in the number range from 300 to 399. The fourth specific embodiment of FIG. 8 is explained only to the extent that it differs from the first through third specific embodiments of FIGS. 1, 2 and 5A through 7, their explanation otherwise also being referenced for the description of the fourth specific embodiment of FIG. 8.

Like the third specific embodiment, the fourth specific embodiment also shows a third joining area 376 shielding second joining area 370 outward with respect to outer surroundings U. With respect to third joining area 376, joining flanges 332 and 334 project outward toward external surroundings U and form a recess 374, as it is in a similar way already known from the second specific embodiment.

On their end faces 332a and 334a, joining flanges 332 and 334 may have cross pieces 332b and 334b, respectively, running toward each other, which are indicated only by dashed lines in FIG. 8. Crosspieces 332b and 334b may be welded to each other at their mutually facing connecting surface sections, so that recess 374 forms a closed volume, in particular a volume circumferentially closed around tank 10.

Third joining area 376 is then formed in two parts with an area situated radially within recess 374 and an area formed by the joining surface of crosspieces 332b and 334b and situated outside of recess 374.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-13. (canceled)

14. A motor vehicle tank, comprising a first tank shell and a second tank shell, the first tank shell and the second tank shell defining between each other at least one section of a tank volume of the motor vehicle tank, the first tank shell and the second tank shell respectively having an edge area having a joining flange, the first tank shell and the second tank shell being integrally joined at their joining flanges across a common joining surface, the first tank shell and the second tank shell respectively being a multicomponent tank shell, which comprises a barrier film and at least on its edge area an inner wall section injection molded onto the inner side of the barrier film pointing to the tank volume as well as an outer wall section injection molded onto the outer side of the barrier film pointing away from the tank volume, wherein the barrier film of each tank shell is formed in such a way that in the approach to the common joining surface, it runs away from the tank volume and toward the outer tank side, so that the integral joint of the tank shells is formed from a first joining area, situated closer to the tank volume, in which the injection molded inner tank wall sections of the two tank shells are joined to each other, and a second joining area situated further removed from the tank volume, in which the barrier films of the two tank shells are joined to each other.

15. The motor vehicle tank as recited in claim 14, wherein the first joining area and the second joining area lie in a common joining plane,

16. The motor vehicle tank as recited in claim 14, wherein the injection molded outer wall sections of the first tank shell and of the second tank shell are situated at least along a joining section around the tank volume spatially separated from each other by the barrier film.

17. The motor vehicle tank as recited in claim 14, wherein the integral joint has a third joining area further removed from the tank volume than the second joining area, in which the injection molded outer tank wall sections of the two tank shells are joined to each other.

18. The motor vehicle tank as recited in claim 14, wherein the second joining area shields the first joining area radially outward at least along a joining section around the tank volume.

19. The motor vehicle tank as recited in claim 17, wherein the third joining area shields the second joining area radially outward at least along a joining section around the tank volume.

20. The motor vehicle tank as recited in claim 14, wherein, when viewing the joining surface of the barrier film of a tank shell from the respectively other tank shell, the barrier film is convexly curved in the area of the joining surface, the convexly curved area forming the second joining area.

21. The motor vehicle tank as recited in claim 14, wherein, when viewing a tank shell from the outside toward the tank volume, the barrier film is concavely curved and/or flat and inclined toward the joining surface.

22. The motor vehicle tank as recited in claim 14, wherein the barrier film together with the joining surface encloses an angle of no more than 80°.

23. The motor vehicle tank as recited in claim 14, wherein the barrier film together with the joining surface encloses an angle of no more than 70°.

24. The motor vehicle tank as recited in claim 14, wherein the barrier film together with the joining surface encloses an angle of no more than 60° or 50°.

25. The motor vehicle tank as recited in claim 14, wherein the integral joint between the first tank shell and the second tank shell runs in a closed loop around the tank volume.

26. The motor vehicle tank as recited in claim 14, wherein in the lateral sense of the joining surface, the barrier film reaches, at least in circumferential sections along the circumference of the motor vehicle tank, the joining surface in those 50% of the lateral extension of the joining surface which are located radially further outside.

27. The motor vehicle tank as recited in claim 26, wherein in the lateral sense of the joining surface, the barrier film along the entire circumference of the motor vehicle tank, reaches the joining surface in those 50% of the lateral extension of the joining surface which are located radially further outside.

28. The motor vehicle tank as recited in claim 14, wherein in the lateral sense of the joining surface, the barrier film reaches, at least in circumferential sections along the circumference of the motor vehicle tank, the joining surface in those 25% of the lateral extension of the joining surface which are located radially further outside.

29. The motor vehicle tank as recited in claim 28, wherein in the lateral sense of the joining surface, the barrier film along the entire circumference of the motor vehicle tank, reaches the joining surface in those 25% of the lateral extension of the joining surface which are located radially further outside.

30. The motor vehicle tank as recited in claim 29, wherein in the lateral sense of the joining surface, the barrier film along the entire circumference of the motor vehicle tank, reaches the joining surface in those 10% of the lateral extension of the joining surface which are located radially further outside.

31. The motor vehicle tank as recited in claim 14, wherein the barrier film emerges from the joining flange at a distance from the joining surface from an end face of the joining flange of a tank shell pointing away from the tank volume.

32. The motor vehicle tank as recited in claim 14, wherein the barrier film, as it approaches the joining surface, moves further away from the tank volume than the inner tank side, which is formed by the inner tank wall section that is injection molded onto the inner side of the barrier film.
